(19) United States
(12) Patent Application Publication
(10) Pub. No.: US 2023/0186172 A1
(43) Pub. Date: Jun. 15, 2023

(54) FEDERATED LEARNING OF MACHINE LEARNING MODEL FEATURES

(71) Applicant: INTERNATIONAL BUSINESS MACHINES CORPORATION, Armonk, NY (US)

(72) Inventors: Giulio ZIZZO, Dublin (IE); Ambrish RAWAT, Dublin (IE); Mark PURCELL, Naas (IE)

(73) Assignee: INTERNATIONAL BUSINESS MACHINES CORPORATION, Armonk, NY (US)

(21) Appl. No.: 17/644,077

(22) Filed: Dec. 13, 2021

(51) Int. Cl. G06N 20/20

(52) U.S. Cl. CPC G06N 20/20

(57) ABSTRACT

Embodiments for providing enhanced adversarial robustness of machine learning models using certification for federated learning in a computing environment by a processor. Machine learning model updates, a dataset, and a set of hyperparameters may be received. One or more certification parameters and one or more filtered machine learning model updates for a machine learning model may be generated by certifying each of plurality of data points using one or more abstract representations in a machine learning operation and filtering the plurality of machine learning model updates.

### BACKGROUND OF THE INVENTION

### Field of the Invention

The present invention relates in general to computing systems, and more particularly to, various embodiments for providing enhanced adversarial robustness of machine learning models using certification for federated learning in a computing environment using one or more computing processors.

### Description of the Related Art

In today's society, consumers, business persons, educators, and others use various computing network systems with increasing frequency in a variety of settings. Computer systems may be found in the workplace, at home, or at school. Computer systems may include data storage systems, or disk storage systems, to process and store data. In recent years, both software and hardware technologies have experienced amazing advancement. With the new technology, more and more functions are added, and greater convenience is provided for use with these computing systems. For example, a wide variety of computer systems have been used in machine learning. Machine learning is a field of artificial intelligence that uses statistical techniques to allow computers to learn from data without being explicitly programmed.

### SUMMARY OF THE INVENTION

Various embodiments for providing enhanced adversarial robustness of machine learning models using certification for federated learning in a computing environment by a processor, are provided. In one embodiment, by way of example only, a method for providing enhanced adversarial robustness of machine learning models using certification for federated learning (e.g., providing optimized machine learning model features using federated learning data) in a computing environment, again by a processor, is provided. Machine learning model updates, a dataset, and a set of hyperparameters may be received. One or more certification parameters and one or more filtered machine learning model updates for a machine learning model may be generated by certifying each of plurality of data points using one or more abstract representations in a machine learning operation and filtering the plurality of machine learning model updates.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 is an additional block diagram depicting an exemplary cloud computing environment according to an embodiment of the present invention.

FIG. 3 is an additional block diagram depicting abstraction model layers according to an embodiment of the present invention.

FIG. 4 is an additional block diagram depicting an exemplary functional relationship between various aspects of the present invention.

FIG. 5A-5B are additional block diagrams depicting operations of providing enhanced adversarial robustness of machine learning models using certification for federated learning in which aspects of the present invention may be realized.

FIG. 6 is a flowchart diagram depicting an exemplary method for providing enhanced adversarial robustness of machine learning models using certification for federated learning in accordance with aspects of the present invention.

FIG. 7 is a flowchart diagram depicting an exemplary method for providing enhanced adversarial robustness of machine learning models using certification for federated learning in a computing system in which aspects of the present invention may be realized.

### DETAILED DESCRIPTION OF THE DRAWINGS

The present invention relates generally to the field of artificial intelligence (“AI”) such as, for example, machine learning and/or deep learning. Machine learning allows for an automated processing system (a “machine”), such as a computer system or specialized processing circuit, to develop generalizations about particular data sets and use the generalizations to solve associated problems by, for example, classifying new data. Once a machine learns generalizations from (or is trained using) known properties from the input or training data, it can apply the generalizations to future data to predict unknown properties.

In machine learning and cognitive science, neural networks are a family of statistical learning models inspired by the biological neural networks of animals, and in particular the brain. Neural networks can be used to estimate or approximate systems and functions that depend on a large number of inputs and are generally unknown. Neural networks use a class of algorithms based on a concept of inter-connected “neurons.” In a typical neural network, neurons have a given activation function that operates on the inputs. By determining proper connection weights (a process also referred to as “training”), a neural network achieves efficient recognition of desired patterns, such as images and characters. Oftentimes, these neurons are grouped into “layers” in order to make connections between groups more obvious and to each computation of values. Training the neural network is a computationally intense process. For example, designing machine learning (ML) models, particularly neural networks for deep learning, is a trial-and-error process, and typically the machine learning model is a black box.

Additionally, training via federated learning (FL) is increasingly popular due to the many strengths of FL, which include reducing communication overheads, decentralizing computations, and preserving data privacy. Federated learning is a machine learning technique that facilitates training a global machine learning model from data distributed across multiple sites, without having to move the data. This is achieved through an iterative process of training models locally, transmitting updates of local models' weights to an aggregator server, and updating the global model to be shared with the sites. Federated learning can be used for training any type of machine learning algorithm such as, for example, deep neural networks (DNN), using the multiple local datasets contained in the multiple sites. The aggregator server and the multiple sites (or “local nodes”) exchange parameters (e.g., the weights of a deep neural network) between these local nodes at a predetermined frequency to generate the global machine learning model.

However, FL offers new attack opportunities to an adversary. For example, in FL many clients wish to learn a common machine learning model, and each client trains using their local data. Once the clients have updated their local machine learning model, the client sends their trained weights to an aggregator. The aggregator combines the received weights producing an updated model. The machine learning model is then sent to the clients for a new training round. However, malicious clients can propose arbitrary updates pursuing objectives such as preventing convergence or inserting backdoors. Attackers can participate in FL and pursue objectives such as inserting backdoors or preventing model convergence. To combat this, several schemes have been developed such as, for example, operations that offer protection if the proportion of malicious clients does not exceed particular thresholds. For example, median based robust aggregation schemes require the majority of the clients participating in a round of FL to be benign. However, having this assurance in practical settings at all times can be difficult to maintain: benchmark FL systems have many thousands of users, of which only a small proportion participate in any one FL round. Therefore, if clients are modelled as randomly participating, or worse if they can join at will, then it is likely that a round of FL will occur in which the quorum of participating clients is maliciously dominated breaking robust aggregation defenses. In parallel, it is known that neural networks are vulnerable to adversarial examples, which in turn can be mitigated using adversarial training. The interaction of adversarial training with FL may include result showing federated adversarial training's sensitivity to the amount of local compute, that not all clients need to necessarily perform adversarial training to achieve robustness, as well as specialized attacks against federated adversarial training.

Additionally, a more dangerous kind of attack may be present where an adversary replaces a machine learning model, which is undergoing adversarial training, with one that is only superficially robust such as, for example, due to gradient masking. In this case, the defender can be unaware that the machine learning model has been compromised. Robust aggregation defenses rely on bounding the number of malicious clients k present in a quorum of n clients. Median based defenses handle at most [n/2]−1 malicious clients, an aggregation rule (e.g., “Krum”) needs n>2k+2 [3], or another aggregation rule (e.g., Bulyan) requires n≥4k+3.

However, benchmark datasets for simulating real FL have a very small proportion of clients participating in a round. This raises difficulties for such defenses as, even if there is a small proportion of adversaries in a system, it is likely that given sufficient training rounds, there may be rounds in which the threshold requirements for robust aggregation schemes are broken.

Therefore, to offer protection in this challenging environment, the present invention provides certification-based approaches for providing a robust aggregation for federated learning.

Thus, a need exits for providing federated learning of machine learning model features in distributed datasets having various boundaries and limitations preventing aggregated information as inputs into machine learning models. Accordingly, various embodiments are provided herein for providing federated learning of machine learning model using abstract interpretation operations to ensure that the resulting aggregated model is robust and not stealthily compromised.

In some implementations, the present invention provides for enhanced adversarial robustness of machine learning models using certification for federated learning (e.g., providing optimized machine learning model features using federated learning data) in a computing environment, again by a processor, is provided. Machine learning model updates, a dataset, and a set of hyperparameters may be received. One or more certification parameters (e.g., certification metric) and one or more filtered machine learning model updates for a machine learning model may be generated by certifying each of plurality of data points using one or more abstract representations in a machine learning operation and filtering the plurality of machine learning model updates.

In this way, an abstract interpretation may be used and is determined to be “sound” if it is impossible for a datapoint, which was certified to have its predicted class changed under any circumstance, subject to a defined bound. Certification of a datapoint indicates if it is possible for its predicted class to be changed. The certification helps filter out or discard undesirable updates during the training process. This certification layer can be easily enabled as a plug-n-play module in conjunction with any robust aggregation method.

In one aspect, the input data may include, for example, data labels (e.g., distributed and/or centralized), raw data (distributed), local machine learning models for feature extractions, a central machine learning model for combining the feature, hyperparameters configuring the federated machine learning. Hyperparameters (e.g., the number of iterations in the gradient-based optimization) may be a step size of gradient updates (“learning rate”), a size of data batches on which to compute the gradients, and/or a strength of model regularizes as part of the training objective.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

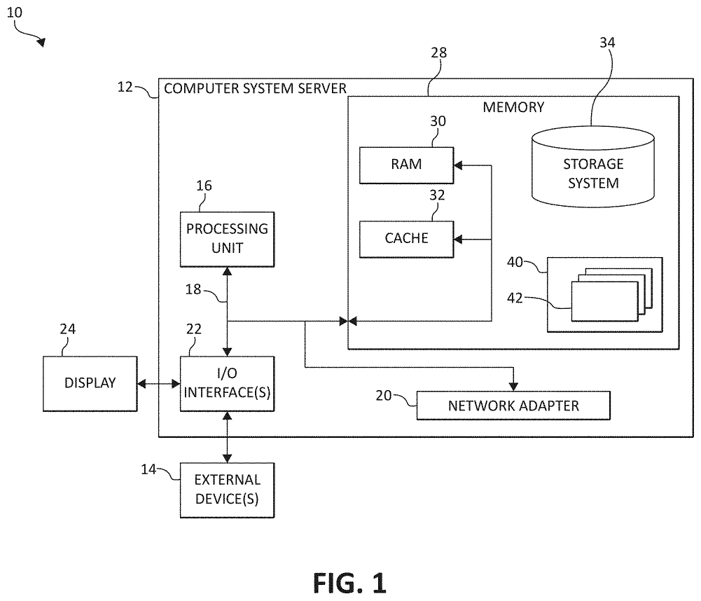

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 12.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

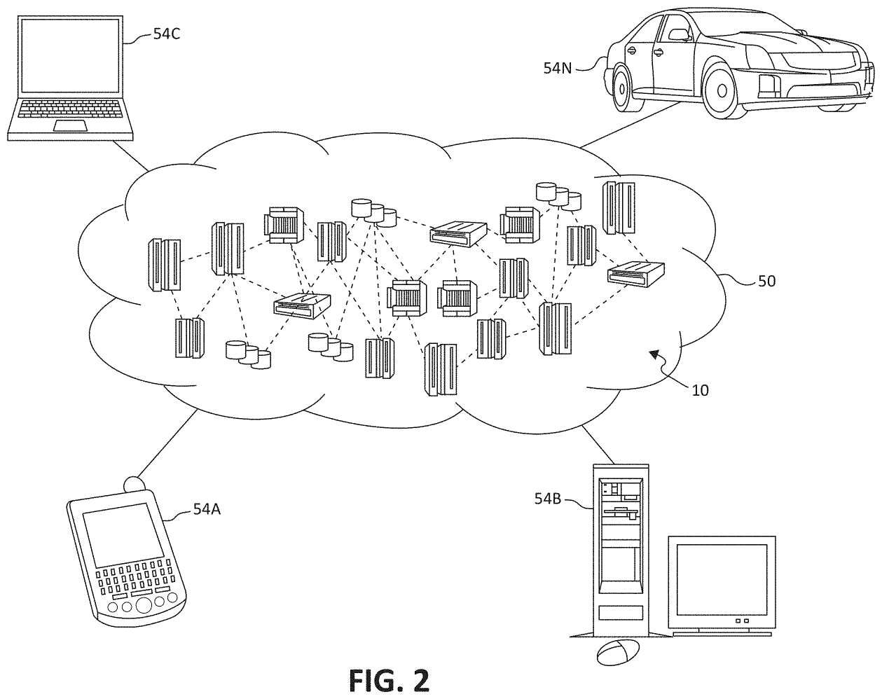

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

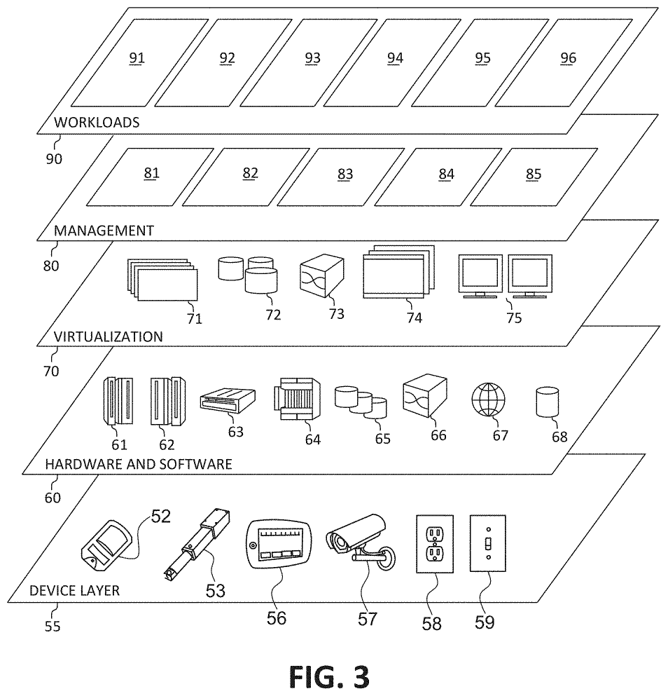

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing enhanced adversarial robustness of machine learning models using certification for federated learning. In addition, workloads and functions 96 for providing enhanced adversarial robustness of machine learning models using certification for federated learning may include such operations as data analytics, data analysis, and as will be further described, notification functionality. One of ordinary skill in the art will appreciate that the workloads and functions 96 for providing enhanced adversarial robustness of machine learning models using certification for federated learning may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As mentioned previously, the present invention provides for enhanced adversarial robustness of machine learning models using certification for federated learning (e.g., providing optimized machine learning model features using federated learning data) in a computing environment, again by a processor, is provided. Machine learning model updates, a dataset, and a set of hyperparameters may be received. One or more certification parameters and one or more filtered machine learning model updates for a machine learning model may be generated by certifying each of plurality of data points using one or more abstract representations in a machine learning operation and filtering the plurality of machine learning model updates.

For example, consider the following federate adversarial training operation when a defender seeks to train a model that is robust to evasion attacks at deployment, more specifically adversarial examples. Adversarial Training is the only defense known to impart empirical robustness to ML models. A defender would therefore be likely to conduct federated adversarial training. However, the federate adversarial training is vulnerable to attacks inserted via masked gradients. However, an abstract interpretation, as used herein, can determine if a machine learning model has been stealthily weakened such as, for example, via gradient masking attacks. In such a scenario, an attacker inserts a L_{infinity} bounded backdoor in a federated learning round. By specifying an L_{infinity} bound in abstract interpretation, the present invention can identify one or more weakness in a machine learning models (e.g., identify areas in the machine learning model subject to adversarial attack).

In some embodiments, certification of neural networks is a research area orthogonal to FL. Via certifiable methods a defender has a guarantee whether a datapoint can have its prediction changed, which can be used to uncover stealthy model compromise. More precisely, given a neural network f, the defender wishes to verify that the predicted label for all inputs from a p-norm ball B_{ϵ}^{p} of size ϵ centred on the datapoint x are classified to the same class T, as illustrated in equation 1:

f(x′)=T ∀x′∈B_{ϵ}^{p}(x)={x′=x+δ||p≤|ϵ|ₚ} (1),

where f is a neural network, and B defines an Lₚ bound around the input x of size ϵ, and a datapoint is certifiably classified if all possible inputs from B result in the same prediction T.

It should be noted that as used herein, an Lₚ bound defines how much a datapoint could be perturbed by an attacker. Common bounds may be as follows. One common bound may be L_{infinity} which specifies a maximum change that can be applied to a feature in a datapoint (e.g., if L_{infinity}=0.2, then each feature can be modified by a maximum of 0.2. Another common bound may be L₀ which describes a total number of features that can be changed. The affected features can be altered by any amount. Another common bound may be L₂ which is a Euclidian distance between a perturbed and original datapoint.

Returning now to equation (1), if such a condition holds, then a datapoint is certified. Also, neural networks may be certified by measuring the proportion of datapoints it can certifiably classify. In some aspects, a defender may be modeled using abstract interpretation operations to verify the adversarial robustness of the machine learning model. A datapoint's abstract representation may be passed through the neural network in a domain such as, for example, an interval, zonotope, octagon, or polyhedral. More precisely, a concrete input x may be represented with all its possible perturbations with an abstract element \hat{x}.

The abstract element will capture the entirety of B_{ϵ}^{p}. By passing the abstract element \hat{x} through the neural network, and analysing its abstract output ŷ, the present invention may check if a robustness property holds for the neural network. The various abstract representations that may be passed through the neural network may trade precision for scalability. For example, a zonotope domain may be used to provide strong performance while remaining computationally tractable for neural networks of realistic size,

Thus, to check that for all of B there are the same predictions, the present invention uses abstract interpretation. That is, in some implementations, a concrete datapoint x is converted into its abstract representation, which captures all of B. By pushing the abstract representation though a neural network an analyzing the output of the abstract representation, the present invention is able to determine whether any datapoint in B could result in a neural network changing its prediction.

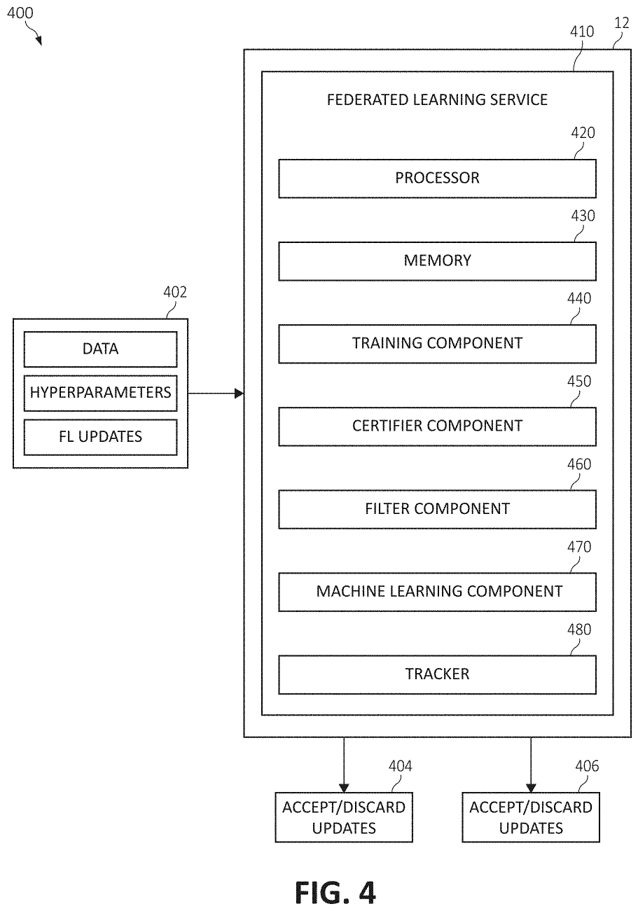

Turning now to FIG. 4, a block diagram depicting exemplary functional components 400 according to various mechanisms of the illustrated embodiments is shown. In one aspect, one or more of the components, modules, services, applications, and/or functions described in FIGS. 1-3 may be used in FIG. 4. Repetitive description of like elements employed in other embodiments described herein is omitted for sake of brevity.

A federated learning service 410 is shown, incorporating processing unit (“processor”) 420 to perform various computational, data processing and other functionality in accordance with various aspects of the present invention. The federated learning service 410 may be provided by the computer system/server 12 of FIG. 1. The processing unit 420 may be in communication with memory 430. The federated learning service 410 may include a training component 440, a certifier component 450, a filter component 460, a machine learning component 470, and a tracker component 480.

As one of ordinary skill in the art will appreciate, the depiction of the various functional units in federated learning service 410 is for purposes of illustration, as the functional units may be located within the federated learning service 410 or elsewhere within and/or between distributed computing components.

In general, by way of example only, the federated learning service 410 may receive input data 402 such as, for example, data or dataset, hyperparameters, and/or federated learning updates (e.g., federated learning machine learning model updates). That is, the federated learning service 410 may receive input data 402, which may be: 1) data, 2) a model, 3) defender-specified certification parameters (e.g., Lₚ bound, certification domain, etc.).

The federated learning service 410, using the training component 440, the certifier component 450, the filter component 460, the machine learning component 470, and the tracker component 480, may generate one or more certification parameters (e.g., a certification metric 404) and one or more filtered machine learning model updates (e.g., filtered updates) for a machine learning model by certifying each of plurality of data points using one or more abstract representations in a machine learning operation and filtering the plurality of machine learning model updates, where the abstract representations may represent each one of the plurality of data points. Each of the filtered updates may be accepted or rejected, as depicted in block 406. That is, for each round of federated learning, a decision (e.g., accept or reject or a “yes” or “no” decision) as to whether the aggregated machine learning model has been stealthily compromised in regards to its adversarial robustness is performed.

The federated learning service 410 may learn machine learning model features/updates from one or more data sets extracted from one or more localized machine learning models associated with one or more nodes (e.g., local nodes).

The federated learning service 410, using the training component 440, the certifier component 450, the filter component 460, the machine learning component 470, and the tracker component 480, may transform the dataset into one or more abstract representations representing each one of a plurality of data points. That is, the data/dataset is converted to its abstract representation, which represents all possible ways the data could be manipulated within the specified bounds.

The certifier component 450 may execute a certification step by passing an abstract representation, corresponding to each data point, through a neural network. That is, the abstract representation may be sent/pushed through a neural network. The certifier component 450 may then identify or determine if the datapoint could be misclassified under the given bounds.

The filtering component 460 may filter the plurality of machine learning model updates by accepting or rejecting one or more of the plurality of machine learning model updates. The filtering component 460, in association with the certifier component 450, may maintain one or more certification statistics to accept those of the plurality of machine learning model updates associated with one or more clients during the filtering.

The tracker component 480 may track one or more certification statistics to accept those of the plurality of machine learning model updates for one or more clients. That is, the per-client certifiable statistics are optionally tracked by the tracker component 480.

The federated learning service 410, using the training component 440, the certifier component 450, the filter component 460, the machine learning component 470, and the tracker component 480, may accept one or more of the plurality of machine learning model updates for those of the one or more certification parameters above a defined threshold. The training component 440 may train a centralized machine learning model using the one or more certification parameters and the one or more filtered machine learning model updates.

In an additional aspect, the machine learning component 470 may be initialized to map input data to a feature vector, initialize one or more parameters of the one or more localized machine learning models or the centralized machine learning model, iteratively update the one or more parameters, perform a forward pass using a machine learning operation to infer the one or more parameters, perform a backward pass using a machine learning operation to determine one or more gradients for the one or more parameters, or perform a combination thereof.

In one aspect, the various machine learning operations of the machine learning component 470, as described herein, may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

Additionally, the federated learning service 410 (using one or more components therein) may perform one or more various types of calculations or computations. The calculation or computation operations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

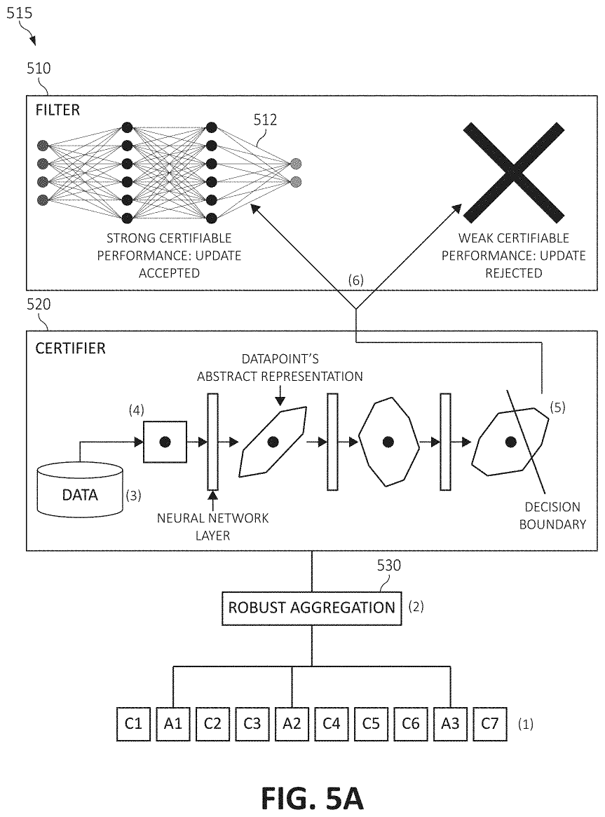

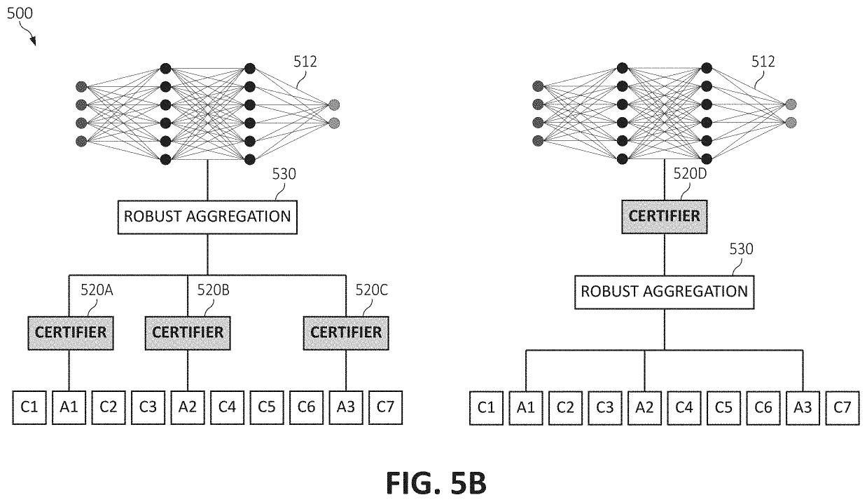

For further explanation, FIG. 5A-5B are additional block diagrams depicting operations of providing enhanced adversarial robustness of machine learning models using certification for federated learning in which aspects of the present invention may be realized. In one aspect, one or more of the components, modules, services, applications, and/or functions described in FIGS. 1-4 may be used in FIGS. 5A-5B. Repetitive description of like elements employed in other embodiments described herein is omitted for sake of brevity. Thus, as depicted in FIGS. 5A-5B, the present invention provides for providing enhanced adversarial robustness of machine learning models using certification for federated machine learning (“FML”).

As a preliminary matter, as depicted in FIGS. 5A-5B, a filter component 510 (see also the filter component 460 of FIG. 4) and a certifier component 520 (see also the certifier component 450 of FIG. 4) are in communication with each other. In one aspect, the certifier component 520 can function on different abstract domains (e.g., box, zonotope, octagon, Polyhedra, etc). These domains trade scalability for precision in the analysis. In some implementations, the filter component 510 can be based on thresholding. However, complex model based decisions can also be used to filter the updates.

In one aspect, a neural network 512 is in communication with one or more local nodes or “participants” such as, for example, clients (“C”) (e.g., C1-C7). Also one or more compromised clients/adversarial attackers (“A”) (e.g., A1-A3) may be present.

In operation, in an initial operation, a central aggregator 530 (e.g., a robust aggregation) initiates a round of federated training, and dispatches relevant parameters to all the participating clients (e.g., initial global model, training hyperparameters, etc.).

In step (1), each of the participants (e.g., the clients and/or the adversarial attackers) communicate updates to the central aggregator 530.

In step (2), a robust aggregation operation (e.g., median, Krum, etc.) may be applied to each of the machine learning model federated learning updates. The output of the central aggregator 530 is an aggregated machine learning model.

In step (3), the certifier component 520 has a held out set of data and receives the aggregated machine learning model.

In step (4), the certifier component 520 selects or picks certification domain (e.g., box, zonotope, polytope).

In step (5), the certifier component 520 passes the held out set of data of item in the selected abstract domain through the neural network 512. The output of this stage is a set of user defined certification metrics (e.g., certifiable accuracy/certifiable loss over the data in item (4)).

. For example, as depicted in FIG. 5A, the zonotope crosses the machine learning model's decision boundary. This means, for that datapoint, it is not certifiably accurate (datapoint could be misclassified). The amount by which the zonotope crosses the boundary can give a certifiable loss.

Moving now to the filtering operation, in step (6), if the certifiable metrics are above a user defined threshold, the client updates may be accepted by the filter component 510 and the global machine learning model is updated. However, the filter component 510 may discard the client updates and continue the federated learning process from the original global machine learning model.

Additionally, as depicted in FIG. 5B, there may be a variety of configurations of the system of the present invention such as, for example, the federated learning service 410. For example, a workflow difference is to place the certifier component 520 (see also the certifier component 450 of FIG. 4) and filter component 510 (see also the filter component 460 of FIG. 4) either after the central aggregator 530 (as shown in diagrams) or before the central aggregator 530 and filter on a per client basis. For example, the certifier component 520 (e.g., certifier components 520A-C) are placed between each of the participants/clients and the central aggregator 530. Alternatively, in other implementations, the certifier component 520 is placed between each of the neural network 512 and the central aggregator 530. The choice of workflow can depend on the computational budget for processing a set of updates or hyperparameters obtained from user like frequency of certification etc.

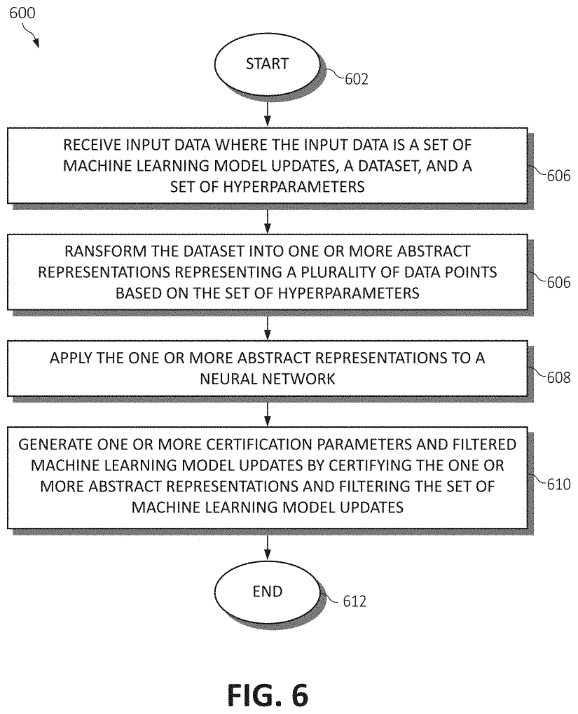

FIG. 6 is a flowchart diagram depicting an exemplary method for providing enhanced adversarial robustness of machine learning models using certification for federated learning in a computing environment. In one aspect, each of the devices, components, modules, operations, and/or functions described in FIGS. 1-5A-5B also may apply or perform one or more operations or actions of FIG. 6. The functionality 600 may be implemented as a method executed as instructions on a machine, where the instructions are included on at least one computer readable medium or one non-transitory machine-readable storage medium. The functionality 600 may start in block 602.

Input data may be received, where the input data is a set of machine learning model updates (e.g., federated learning updates from local nodes/clients), a dataset, and a set of hyperparameters, as in block 604. The dataset may be transformed into one or more abstract representations representing each one of a plurality of data points based on the set of hyperparameters, as in block 606. The one or more abstract representations may be sent or passed through a neural network, as in block 608. One or more certification parameters and one or more filtered machine learning model updates for a machine learning model may be generated (e.g., output of the neural network) by certifying each of plurality of data points using one or more abstract representations in a machine learning operation and filtering the plurality of machine learning model updates, as in block 610. The abstract representations represent each one of the plurality of data points. In one aspect, the functionality 600 may end, as in block 610.

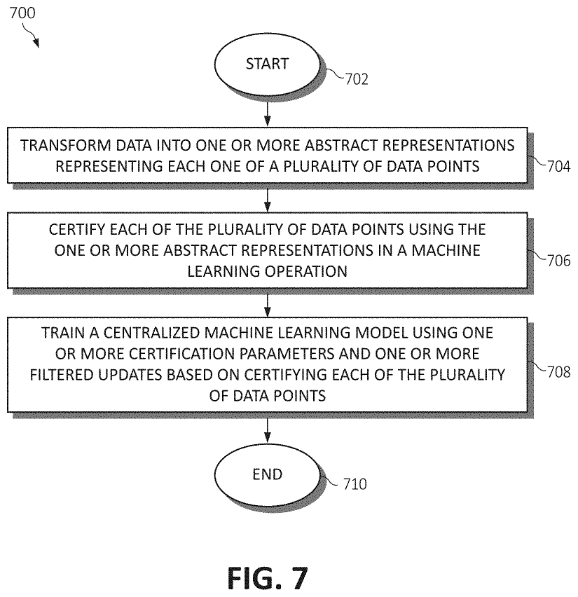

FIG. 7 is a flowchart diagram depicting an exemplary method for providing enhanced adversarial robustness of machine learning models using certification for federated learning in a computing environment. In one aspect, each of the devices, components, modules, operations, and/or functions described in FIGS. 1-6 also may apply or perform one or more operations or actions of FIG. 7. The functionality 700 may be implemented as a method executed as instructions on a machine, where the instructions are included on at least one computer readable medium or one non-transitory machine-readable storage medium. The functionality 700 may start in block 702.

Machine learning model updates, a dataset, and a set of hyperparameters may be received, as in block 704. One or more certification parameters and one or more filtered machine learning model updates for a machine learning model may be generated by certifying each of plurality of data points using one or more abstract representations in a machine learning operation and filtering the plurality of machine learning model updates, as in block 706. In one aspect, the functionality 700 may end, as in block 708.

In one aspect, in conjunction with and/or as part of at least one block of FIG. 7, the operations of method 700 may include each of the following. The operations of method 700 may transform the dataset into one or more abstract representations representing each one of a plurality of data points. The operations of method 700 may train a centralized machine learning model using the one or more certification parameters and the one or more filtered machine learning model updates.

The operations of method 700 may filter the plurality of machine learning model updates by accepting or rejecting one or more of the plurality of machine learning model updates.

The operations of method 700 may maintain one or more certification statistics to accept those of the plurality of machine learning model updates associated with one or more clients during the filtering. The operations of method 700 may track one or more certification statistics to accept those of the plurality of machine learning model updates for one or more clients. The operations of method 700 may accept one or more of the plurality of machine learning model updates for those of the one or more certification parameters above a defined threshold.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, by a processor, for providing enhanced adversarial robustness of machine learning models using certification for federated learning in a computing environment, comprising:
receiving a plurality of machine learning model updates, a dataset, and a set of hyperparameters; and
generating one or more certification parameters and one or more filtered machine learning model updates for a machine learning model by certifying each of plurality of data points using one or more abstract representations in a machine learning operation and filtering the plurality of machine learning model updates, wherein the abstract representations represent each one of the plurality of data points.

2. The method of claim 1, where further including transforming the dataset into one or more abstract representations representing each one of a plurality of data points.

3. The method of claim 1, further including training a centralized machine learning model using the one or more certification parameters and the one or more filtered machine learning model updates.

4. The method of claim 1, further including filtering the plurality of machine learning model updates by accepting or rejecting one or more of the plurality of machine learning model updates.

5. The method of claim 1, further including maintains one or more certification statistics to accept those of the plurality of machine learning model updates associated with one or more clients during the filtering.

6. The method of claim 1, further including tracking one or more certification statistics to accept those of the plurality of machine learning model updates for one or more clients.

7. The method of claim 1, further including accepting one or more of the plurality of machine learning model updates for those of the one or more certification parameters above a defined threshold.

8. A system for providing enhanced adversarial robustness of machine learning models using certification for federated learning in a computing environment, comprising:
one or more computers with executable instructions that when executed cause the system to:
receive a plurality of machine learning model updates, a dataset, and a set of hyperparameters; and
generate one or more certification parameters and one or more filtered machine learning model updates for a machine learning model by certifying each of plurality of data points using one or more abstract representations in a machine learning operation and filtering the plurality of machine learning model updates, wherein the abstract representations represent each one of the plurality of data points.

9. The system of claim 8, wherein the executable instructions that when executed cause the system to transform the dataset into one or more abstract representations representing each one of a plurality of data points.

10. The system of claim 8, wherein the executable instructions that when executed cause the system to train a centralized machine learning model using the one or more certification parameters and the one or more filtered machine learning model updates.

11. The system of claim 8, wherein the executable instructions that when executed cause the system to filter the plurality of machine learning model updates by accepting or rejecting one or more of the plurality of machine learning model updates.

12. The system of claim 8, wherein the executable instructions that when executed cause the system to maintain one or more certification statistics to accept those of the plurality of machine learning model updates associated with one or more clients during the filtering.

13. The system of claim 8, wherein the executable instructions that when executed cause the system to track one or more certification statistics to accept those of the plurality of machine learning model updates for one or more clients.

14. The system of claim 8, wherein the executable instructions that when executed cause the system to accept one or more of the plurality of machine learning model updates for those of the one or more certification parameters above a defined threshold.

15. A computer program product for providing enhanced adversarial robustness of machine learning models using certification for federated learning in a computing environment, the computer program product comprising:
one or more computer readable storage media, and program instructions collectively stored on the one or more computer readable storage media, the program instruction comprising:
program instructions to receive a plurality of machine learning model updates, a dataset, and a set of hyperparameters; and
program instructions to generate one or more certification parameters and one or more filtered machine learning model updates for a machine learning model by certifying each of plurality of data points using one or more abstract representations in a machine learning operation and filtering the plurality of machine learning model updates, wherein the abstract representations represent each one of the plurality of data points.

16. The computer program product of claim 15, further including program instructions to transform the dataset into one or more abstract representations representing each one of a plurality of data points.

17. The computer program product of claim 15, further including program instructions to train a centralized machine learning model using the one or more certification parameters and the one or more filtered machine learning model updates.

18. The computer program product of claim 15, further including program instructions to filter the plurality of machine learning model updates by accepting or rejecting one or more of the plurality of machine learning model updates.

19. The computer program product of claim 15, further including program instructions to:
maintain one or more certification statistics to accept those of the plurality of machine learning model updates associated with one or more clients during the filtering; and
track the one or more certification statistics to accept those of the plurality of machine learning model updates for each of the one or more clients.

20. The computer program product of claim 15, further including program instructions to accept one or more of the plurality of machine learning model updates for those of the one or more certification parameters above a defined threshold.
